(19) United States
(12) Patent Application Publication
(10) Pub. No.: US 2026/0093771 A1
(43) Pub. Date: Apr. 2, 2026

(54) EFFICIENT ONE-DIMENSIONAL (1D) CONVOLUTION SUPPORT ON TWO-DIMENSIONAL (2D) CONVOLUTION ENGINES

(71) Applicant: QUALCOMM Incorporated, San Diego, CA (US)

(72) Inventor: Haoping XU, North York (CA)

(21) Appl. No.: 18/905,058

(22) Filed: Oct. 2, 2024

(51) Int. Cl. G06F 17/15; G06F 12/02

(52) U.S. Cl. CPC G06F 17/15; G06F 12/0223

(57) ABSTRACT

A processor-implemented method for efficient convolution operations includes receiving, by an artificial neural network, an input. The input is mapped to a multiple row input based on a processing capacity of a compute device. The compute device performs concurrent convolution operations according to the multiple row input. An output is generated based on the concurrent convolution operations.

### FIELD OF THE DISCLOSURE

Aspects of the present disclosure generally relate to artificial neural networks and more particularly to efficient processing of convolution operations.

### BACKGROUND

Artificial neural networks may comprise interconnected groups of artificial neurons (e.g., neuron models). The artificial neural network (ANN) may be a computational device or be represented as a method to be performed by a computational device. Convolutional neural networks (CNNs) are a type of feed-forward ANN.

Convolutional neural networks may include collections of neurons that each have a receptive field and that collectively tile an input space. Convolutional neural networks, such as deep convolutional neural networks (DCNs), have numerous applications. In particular, these neural network architectures are used in various technologies, such as image recognition, speech recognition, acoustic scene classification, keyword spotting, autonomous driving, and other classification tasks.

ANN models may be processed using neural processing units (NPUs). NPUs have increasingly been designed to conduct to two-dimensional (2D) or three-dimensional (3D) convolution operations. Hardware designs may focus on 2D convolutions that may heavily rely on 2D inputs and 2D convolution kernels to increase, or possibly maximize, data reuse and performance.

Depending on the total capacity of an NPU multiply-accumulate (MAC) structure, the NPU may compute multiple output rows and multiple output columns concurrently. For instance, a 1K MAC NPU may compute two rows and eight columns concurrently. Another MAC NPU may compute four rows and eight columns concurrently.

However, in conventional approaches, when an input is a single row (e.g., one-dimensional (1D)) with a 1D convolution, only one output row or column is computed. As a result, when the architecture is configured for 2D/3D convolutions, the processing efficiency for 1D convolution operations may be significantly reduced in comparison to 2D/3D convolution operations.

### SUMMARY

Various aspects of the present disclosure are directed to an apparatus. The apparatus has at least one memory and one or more processors coupled to the at least one memory. The processor(s) is configured to receiving, by an artificial neural network, an input. The processor(s) is also configured to map the input to a multiple row input based at least in part on a processing capacity of a compute device. The processor(s) is additionally configured to perform, by the compute device, concurrent convolution operations according to the multiple row input. The processor(s) is further configured to generate an output based on the concurrent convolution operations.

In various aspects of the present disclosure, a processor-implemented method includes receiving, by an artificial neural network, an input. The processor-implemented method also includes mapping the input to a multiple row input based at least in part on a processing capacity of a compute device. The processor-implemented method additionally includes performing, by the compute device, concurrent convolution operations according to the multiple row input. The processor-implemented method further includes generating an output based on the concurrent convolution operations.

Various aspects of the present disclosure are directed to an apparatus. The apparatus includes means for receiving, by an artificial neural network, an input. The apparatus also includes means for mapping the input to a multiple row input based at least in part on a processing capacity of a compute device. The apparatus additionally includes means for performing, by the compute device, concurrent convolution operations according to the multiple row input. The apparatus further includes means for generating an output based on the concurrent convolution operations.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of a neural network using a system-on-a-chip (SOC), including a general-purpose processor in accordance with certain aspects of the present disclosure.

FIGS. 2A, 2B, and 2C are diagrams illustrating a neural network in accordance with aspects of the present disclosure.

FIG. 2D is a diagram illustrating an exemplary deep convolutional network (DCN) in accordance with aspects of the present disclosure.

FIG. 3 is a block diagram illustrating an exemplary deep convolutional network (DCN) in accordance with aspects of the present disclosure.

FIG. 4 is a block diagram illustrating an exemplary software architecture that may modularize artificial intelligence (AI) functions, in accordance with aspects of the present disclosure.

FIG. 5 is a diagram illustrating an example remapping of a one-dimensional (1D) convolution, in accordance with various aspects of the present disclosure.

FIG. 6 is a diagram illustrating an example remapping of a 1D convolution, in accordance with various aspects of the present disclosure.

FIG. 7 is a block diagram illustrating an example remapping of a 1D convolution with hardware padding, in accordance with various aspects of the present disclosure.

FIG. 8 is a flow diagram illustrating an example process for remapping of a 1D convolution with hardware padding, in accordance with various aspects of the present disclosure.

FIG. 9 is a flow diagram illustrating a processor-implemented method for remapping 1D inputs to multi-row input for concurrent convolution operations, in accordance with various aspects of the present disclosure.

### DETAILED DESCRIPTION

The detailed description set forth below, in connection with the appended drawings, is intended as a description of various configurations and is not intended to represent the only configurations in which the concepts described may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used to mean “serving as an example, instance, or illustration. ” Any aspect described as “exemplary” is not necessarily to be construed as preferred or advantageous over other aspects.

Although particular aspects are described, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks, and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Convolution operations are widely employed in machine learning and artificial intelligence. For instance, two-dimensional (2D) convolutions may be used in applications to find features in horizontal and vertical dimensions. Such applications may include (but are not limited to) gesture detection, object segmentation, and facial recognition, for example.

One-dimensional (1D) convolution is also widely used by many applications to find features in one dimension. For example, 1D convolution may be performed in applications including (but not limited to) audio processing where the input is a sequence in time, personalized biomedical data classification, diagnostic and health monitoring, anomaly detection and identification in power electronics, and electrical motor fault detection.

Neural processing units (NPUs) may be designed for two-dimensional (2D)/three-dimensional (3D) convolution operations. That is, the hardware design may be focused on 2D convolutions that may be heavily relied on when presented with 2D inputs (e.g., image data) and 2D convolution kernels to maximize data reuse and processing performance. NPUs may be configured with multiply-accumulate (MAC) units (e.g., 1K MACs or 4K MACs). MAC units may include a multiplier, an adder and an accumulator. MAC units may compute the product of two inputs and add the product to the accumulator.

Depending on the total capacity of an NPU MAC structure, the NPU may compute multiple output rows and multiple output columns concurrently (e.g., at the same time). For example, a 1K MAC NPU may compute two rows and eight columns concurrently. In another example, a 4K MAC NPU may compute four rows and eight columns concurrently.

Accordingly, aspects of the present disclosure are directed to improved 1D convolution operations in NPUs designed for 2D/3D convolutions. In various aspects, an input row may be split into multiple rows to increase utilization of available MAC computation units. Beneficially, aspects of the present disclosure may increase processing efficiency with additional hardware costs and without performing an activation/weight/output copy or reformat operation. Instead, the input and output tensors may be viewed differently by adapting horizontal size and row stride settings.

Particular aspects of the subject matter described in this disclosure can be implemented to realize one or more of the following potential advantages. In some examples, the described techniques (e.g., mapping the input into multiple rows based on a processing capacity) may increase processing efficiency and reduce inference time.

Additionally, aspects of the present disclosure may be applicable to technology areas including (but not limited to) audio processing, personalized biomedical data classification, diagnosis and health monitoring, anomaly detection and identification in power electronics, and electrical motor fault detection.

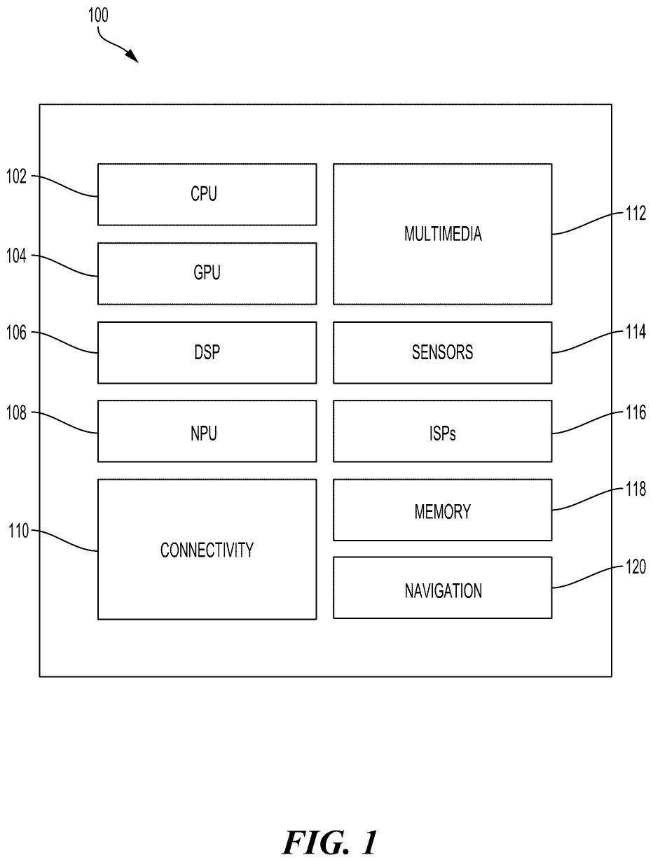

FIG. 1 illustrates an example implementation of a system-on-a-chip (SOC) 100, which may include a central processing unit (CPU) 102 or a multi-core CPU configured for efficient processing of convolution operations. Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU 108 is implemented in the CPU 102, DSP 106, and/or GPU 104. The SOC 100 may also include a sensor processor 114, image signal processors (ISPs) 116, and/or navigation module 120, which may include a global positioning system.

The SOC 100 may be based on an ARM, RISC-V (RISC-five), or any reduced instruction set computing (RISC) architecture. In aspects of the present disclosure, the instructions loaded into the general-purpose processor 102 may include code to receive, by an artificial neural network, an input. The instructions loaded into the general-purpose processor 102 may also include code to map the input to a multiple row input based at least in part on a processing capacity of a compute device. The instructions loaded into the general-purpose processor 102 may additionally include code to perform, by the compute device, concurrent convolution operations according to the multiple row input. The instructions loaded into the general-purpose processor 102 may further include code to generate an output based on the concurrent convolution operations.

Deep learning architectures may perform an object recognition task by learning to represent inputs at successively higher levels of abstraction in each layer, thereby building up a useful feature representation of the input data. In this way, deep learning addresses a major bottleneck of traditional machine learning. Prior to the advent of deep learning, a machine learning approach to an object recognition problem may have relied heavily on human engineered features, perhaps in combination with a shallow classifier. A shallow classifier may be a two-class linear classifier, for example, in which a weighted sum of the feature vector components may be compared with a threshold to predict to which class the input belongs. Human engineered features may be templates or kernels tailored to a specific problem domain by engineers with domain expertise. Deep learning architectures, in contrast, may learn to represent features that are similar to what a human engineer might design, but through training. Furthermore, a deep network may learn to represent and recognize new types of features that a human might not have considered.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

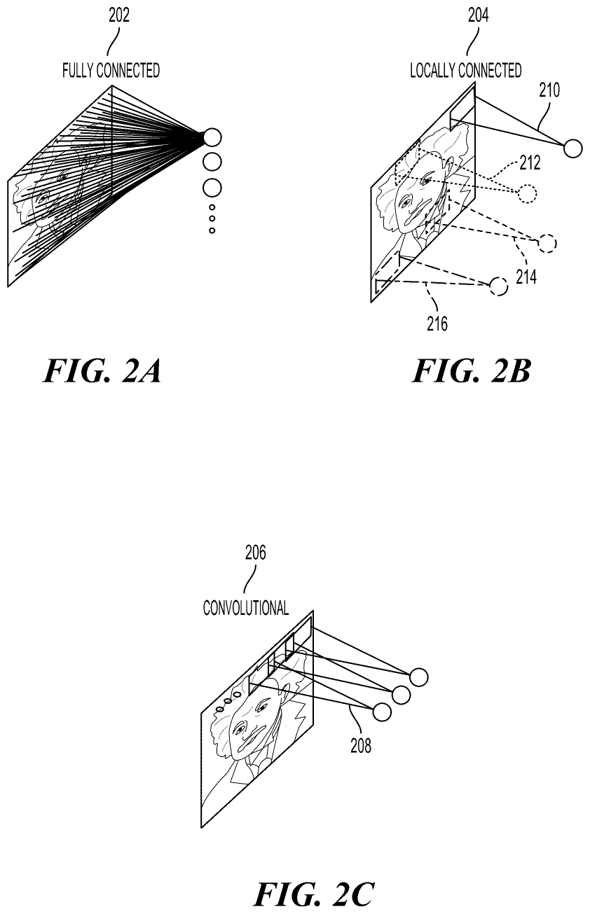

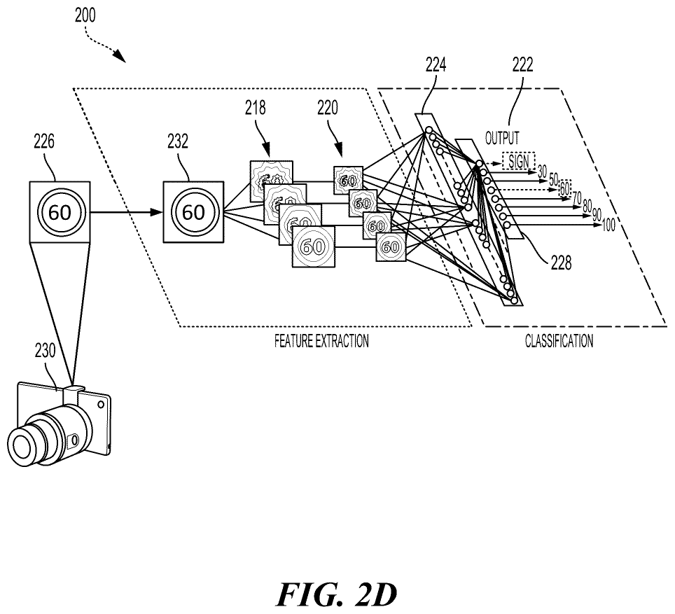

The connections between layers of a neural network may be fully connected or locally connected. FIG. 2A illustrates an example of a fully connected neural network 202. In a fully connected neural network 202, a neuron in a first layer may communicate its output to every neuron in a second layer, so that each neuron in the second layer will receive input from every neuron in the first layer. FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer because the higher layer neurons in a given region may receive inputs that are tuned through training to the properties of a restricted portion of the total input to the network.

One example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful.

One type of convolutional neural network is a deep convolutional network (DCN). FIG. 2D illustrates a detailed example of a DCN 200 designed to recognize visual features from an image 226 input from an image capturing device 230, such as a car-mounted camera. The DCN 200 of the current example may be trained to identify traffic signs and a number provided on the traffic sign. Of course, the DCN 200 may be trained for other tasks, such as identifying lane markings or identifying traffic lights.

The DCN 200 may be trained with supervised learning. During training, the DCN 200 may be presented with an image, such as the image 226 of a speed limit sign, and a forward pass may then be computed to produce an output 222. The DCN 200 may include a feature extraction section and a classification section. Upon receiving the image 226, a convolutional layer 232 may apply convolutional kernels (not shown) to the image 226 to generate a first set of feature maps 218. As an example, the convolutional kernel for the convolutional layer 232 may be a 5×5 kernel that generates 28×28 feature maps. In the present example, because four different feature maps are generated in the first set of feature maps 218, four different convolutional kernels were applied to the image 226 at the convolutional layer 232. The convolutional kernels may also be referred to as filters or convolutional filters.

The first set of feature maps 218 may be subsampled by a max pooling layer (not shown) to generate a second set of feature maps 220. The max pooling layer reduces the size of the first set of feature maps 218. That is, a size of the second set of feature maps 220, such as 14×14, is less than the size of the first set of feature maps 218, such as 28×28. The reduced size provides similar information to a subsequent layer while reducing memory consumption. The second set of feature maps 220 may be further convolved via one or more subsequent convolutional layers (not shown) to generate one or more subsequent sets of feature maps (not shown).

In the example of FIG. 2D, the second set of feature maps 220 is convolved to generate a first feature vector 224. Furthermore, the first feature vector 224 is further convolved to generate a second feature vector 228. Each feature of the second feature vector 228 may include a number that corresponds to a possible feature of the image 226, such as “sign,” “60,” and “100.” A softmax function (not shown) may convert the numbers in the second feature vector 228 to a probability. As such, an output 222 of the DCN 200 may be a probability of the image 226 including one or more features.

In the present example, the probabilities in the output 222 for “sign” and “60” are higher than the probabilities of the others of the output 222, such as “30,” “40,” “50,” “70,” “80,” “90,” and “100”. Before training, the output 222 produced by the DCN 200 may likely be incorrect. Thus, an error may be calculated between the output 222 and a target output. The target output is the ground truth of the image 226 (e.g., “sign” and “60”). The weights of the DCN 200 may then be adjusted so the output 222 of the DCN 200 is more closely aligned with the target output.

To adjust the weights, a learning algorithm may compute a gradient vector for the weights. The gradient may indicate an amount that an error would increase or decrease if the weight were adjusted. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level. After learning, the DCN 200 may be presented with new images (e.g., the speed limit sign of the image 226) and a forward pass through the DCN 200 may yield an output 222 that may be considered an inference or a prediction of the DCN 200.

Deep belief networks (DBNs) are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information about the class to which each input should be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

DCNs are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer, with each element of the feature map (e.g., 220) receiving input from a range of neurons in the previous layer (e.g., feature maps 218) and from each of the multiple channels. The values in the feature map may be further processed with a non-linearity, such as a rectification, max(0, x). Values from adjacent neurons may be further pooled, which corresponds to down sampling, and may provide additional local invariance and dimensionality reduction. Normalization, which corresponds to whitening, may also be applied through lateral inhibition between neurons in the feature map.

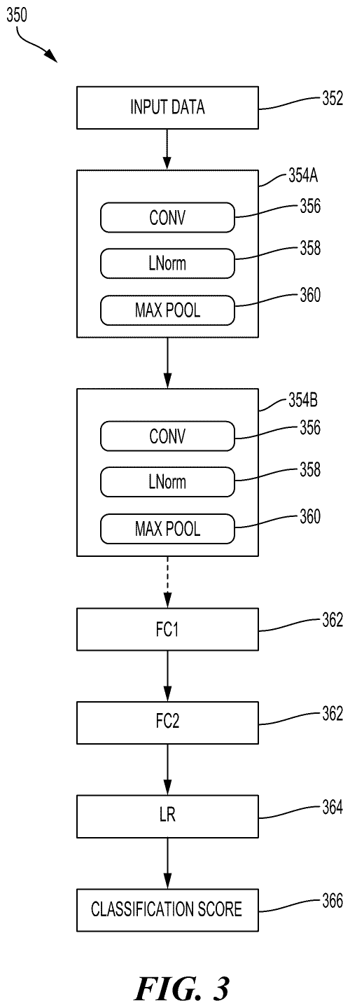

FIG. 3 is a block diagram illustrating a DCN 350. The DCN 350 may include multiple different types of layers based on connectivity and weight sharing. As shown in FIG. 3, the DCN 350 includes the convolution blocks 354A, 354B. Each of the convolution blocks 354A, 354B may be configured with a convolution layer (CONV) 356, a normalization layer (LNorm) 358, and a max pooling layer (MAX POOL) 360.

Although only two of the convolution blocks 354A, 354B are shown, the present disclosure is not so limiting, and instead, any number of the convolution blocks 354A, 354B may be included in the DCN 350 according to design preference.

The convolution layers 356 may include one or more convolutional filters, which may be applied to the input data to generate a feature map. The normalization layer 358 may normalize the output of the convolution filters. For example, the normalization layer 358 may provide whitening or lateral inhibition. The max pooling layer 360 may provide down sampling aggregation over space for local invariance and dimensionality reduction.

The parallel filter banks, for example, of a deep convolutional network may be loaded on a CPU 102 or GPU 104 of an SOC 100 (e.g., FIG. 1) to achieve high performance and low power consumption. In alternative embodiments, the parallel filter banks may be loaded on the DSP 106 or an ISP 116 of an SOC 100. In addition, the DCN 350 may access other processing blocks that may be present on the SOC 100, such as sensor processor 114 and navigation module 120, dedicated, respectively, to sensors and navigation.

The DCN 350 may also include one or more fully connected layers 362 (FC1 and FC2). The DCN 350 may further include a logistic regression (LR) layer 364.

Between each layer 356, 358, 360, 362, 364 of the DCN 350 are weights (not shown) that are to be updated. The output of each of the layers (e.g., 356, 358, 360, 362, 364) may serve as an input of a succeeding one of the layers (e.g., 356, 358, 360, 362, 364) in the DCN 350 to learn hierarchical feature representations from input data 352 (e.g., images, audio, video, sensor data and/or other input data) supplied at the first of the convolution blocks 354A. The output of the DCN 350 is a classification score 366 for the input data 352. The classification score 366 may be a set of probabilities, where each probability is the probability of the input data including a feature from a set of features.

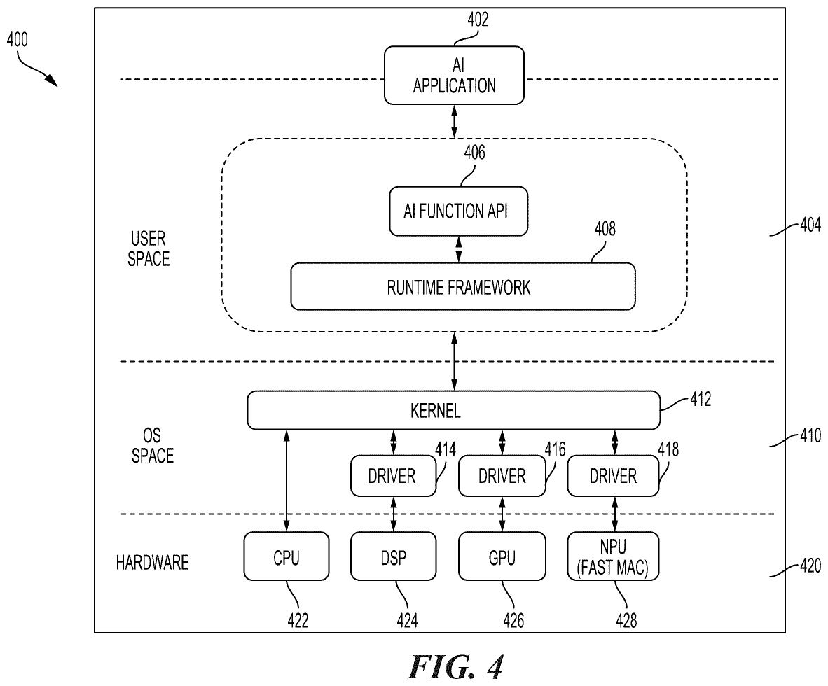

FIG. 4 is a block diagram illustrating an exemplary software architecture 400 that may modularize artificial intelligence (AI) functions. Using the architecture 400, applications may be designed that may cause various processing blocks of an SOC 420 (for example a CPU 422, a DSP 424, a GPU 426 and/or an NPU 428) (which may be similar to SOC 100 of FIG. 1) to support efficient processing of convolution operations for an AI application 402, according to aspects of the present disclosure. The architecture 400 may, for example, be included in a computational device, such as a smartphone.

The AI application 402 may be configured to call functions defined in a user space 404 that may, for example, provide for the detection and recognition of a scene indicative of the location at which the computational device including the architecture 400 currently operates. The AI application 402 may, for example, configure a microphone and a camera differently depending on whether the recognized scene is an office, a lecture hall, a restaurant, or an outdoor setting such as a lake. The AI application 402 may make a request to compiled program code associated with a library defined in an AI function application programming interface (API) 406. This request may ultimately rely on the output of a deep neural network configured to provide an inference response based on video and positioning data, for example.

The run-time engine 408, which may be compiled code of a runtime framework, may be further accessible to the AI application 402. The AI application 402 may cause the run-time engine 408, for example, to request an inference at a particular time interval or triggered by an event detected by the user interface of the AI application 402. When caused to provide an inference response, the run-time engine 408 may in turn send a signal to an operating system in an operating system (OS) space 410, such as a Kernel 412, running on the SOC 420. In some examples, the Kernel 412 may be a LINUX Kernel. The operating system, in turn, may cause a continuous relaxation of quantization to be performed on the CPU 422, the DSP 424, the GPU 426, the NPU 428, or some combination thereof. The CPU 422 may be accessed directly by the operating system, and other processing blocks may be accessed through a driver, such as a driver 414, 416, or 418 for, respectively, the DSP 424, the GPU 426, or the NPU 428. In the exemplary example, the deep neural network may be configured to run on a combination of processing blocks, such as the CPU 422, the DSP 424, and the GPU 426, or may be run on the NPU 428.

As described, aspects of the present disclosure are directed to improved convolution operations in NPUs designed for 2D/3D convolutions. In various aspects, an input row may map into multiple rows to increase utilization of available MAC computation units.

In accordance with aspects of the present disclosure, an input having a first dimension may be split into an input having a second dimension that is larger than the first dimension. For example, where the hardware architecture (e.g., NPU) is configured to concurrently generate multiple rows of outputs, the input dimension may be remapped to utilize the available hardware to thereby increase processing efficiency and reduce output. In one example, when the hardware is configured to output four outputs concurrently, a one-dimensional input may be remapped into four rows of inputs. Of course, the number of output rows, input rows, and remapped input rows are merely examples, and not limiting.

In some aspects, the determination of how to split or remap an input may be based on the number of concurrent output rows (represented as ‘Yc’) computed in the available hardware (e.g., NPU). A split factor N may be determined according to ceiling(Yc/Yi), where Yi represents the number of rows of the input and ceiling is a function, where ceiling(x) maps x to the smallest integer greater than or equal to x (e.g., ceiling(2.001)=3). Then, the input may be remapped by splitting each row of the input into N rows.

In some aspects, additional elements (e.g., zeros) may be added to an input. For instance, given an activation dimension Xi and an output dimension Xo, if the output dimension Xo is not a multiple of the split factor N, the output dimension Xo may be padded to produce Xo′=Ceiling (Xo/N)*N. In turn, the split activation row size Xi′ may be given by Xi′=Xo′ +Kx−1, where Kx represents the kernel dimension.

An NPU (e.g., NPU 108/428) may thus be programmed for activation Xi′*(N*Yi) and kernel dimension Kx*1. The input row may be fetched with row stride Xo′*Ci, where Ci represents a channel of the input. Notably, remapping the input to a remapped input may be performed without moving elements of the input in memory (e.g., 118). That is, the remapping may be performed without performing a tensor copy/reformat. Rather, the remapping may adapt the fetching of the input from memory.

The NPU may compute an output tensor with Xo′*(N*Yi) dimension, where the product N*Yi output rows may be concatenated into Yi output rows when row stride=Xo′. In some aspects, the output dimension Xo may be split into N rows. If the output dimension Xo is not a multiple of N, the output dimension may be padded to form a padded output dimension Xo′. Padding (e.g., hardware padding) involves filling unused portions of a data structure with blank or null characters, for instance.

Padding may be performed, for example, to avoid alignment faults due to accessing unaligned memory. The padded output dimension may be given by Xo′=Ceiling (Xo/N)*N.

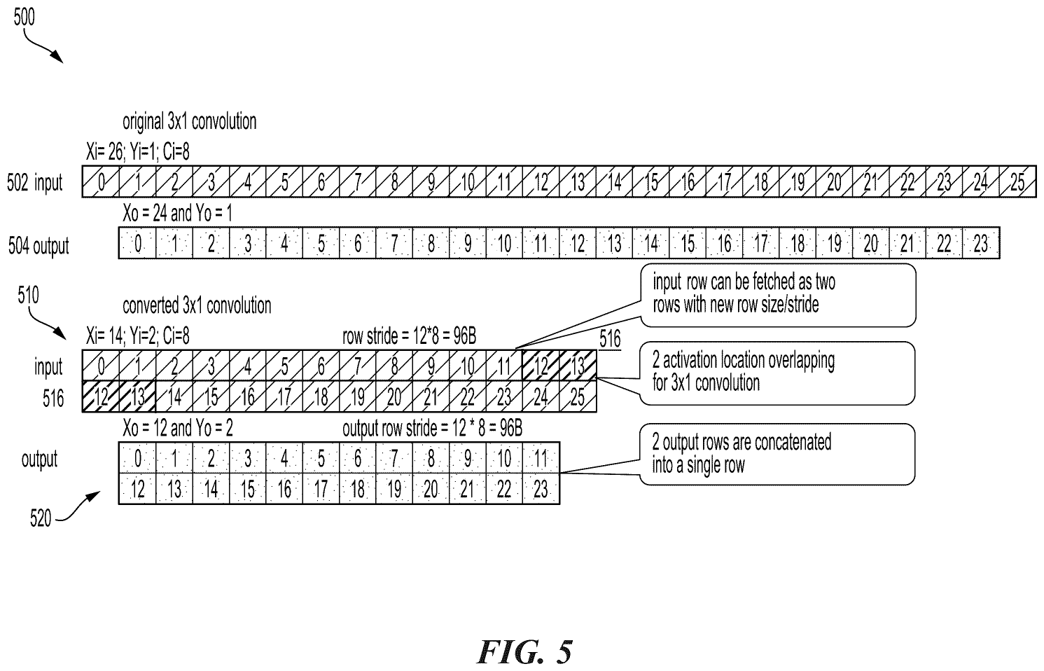

FIG. 5 is a diagram illustrating an example remapping of a 1D convolution 500, in accordance with various aspects of the present disclosure.

Referring to FIG. 5, an artificial neural network (e.g., DCN 350 of FIG. 3) may receive a 1D (e.g., single row) input 502. The single row input 502 may include 26 elements (e.g., elements 0-25), for example. Of course this is merely an example, and the single row input 502 may include any number of elements. Each element of the single row input 502 may include eight channels for instance. The single row input 502 may comprise (but is not limited to) an audio input, biomedical data, or an indication of a power/electrical signal, for instance.

In the example of FIG. 5, a 3×1 convolution operation may be scheduled for the single row input 502 which would generate an output 504. For instance, the eight channels of elements 0, 1, and 2 of the single row input 502 may be convolved to generate a first element of the output 504. Then, elements 1, 2, and 3 may be convolved to generate a second element of the output 504. Thereafter, successive sets of input elements may be convolved to generate the remaining elements of the output 504.

The inputs (e.g., 502) of the convolution operation may be remapped to utilize available compute resources more efficiently. In the example, of FIG. 5, the single row input 502 may be remapped as a multi-row input 510 based on the available compute resources. That is, when the hardware configuration may concurrently process multiple rows of inputs to generate multiple rows of outputs, the single row input 502 may be remapped to increase processing efficiency and reduce latency. For instance, the remapping may split the single row input 502 in two, such that input rows may be fetched as two rows with a new row size (e.g., stride).

To determine the size of the split (e.g., the number of rows) for the single row input 502, the number of concurrent outputs that may be generated by the hardware configuration may be employed, for example. In this example, the number of outputs 504 concurrently generated (Yc) may be two. Of course, the number of the concurrent outputs is merely an example and not limiting, any number of concurrent outputs may be generated subject to hardware limitations. The number of rows of the single row input 502 (Yi) is one. Thus, the split factor (N), in this example is two. Accordingly, the output 504 may be mapped to split the output 504 into two rows (e.g., multi-row output 520). Then, the single row input 502 may be mapped to split the input 502 into two rows in the multi-row input 510.

The split activation row size Xi′ may then be determined based on the size of the Xo′. As shown in the FIG. 5, Xo′=12, the kernel dimension is 3. Thus, the desired split activation row size Xi′=14. That is, the mapped input may include 14 elements in each row.

In some aspects, because outputs may be produced by the convolution of inputs that are common with a preceding output, two elements of the input 502 may be overlapped or repeated as the end of a first row of the multi-row input 510 and the beginning of the second row of the multi-row input (shown as overlapped elements 516).

Having remapped the single row inputs 502 as multi-row input 510, the convolution operations may be performed by fetching the elements on the single row input 502 in accordance with the remapping, such that the two rows of the multi-row input 510 may be concurrently processed to generate the multi-row outputs 520. In some aspects, the rows of the multi-row output 520 may be concatenated to remap the multi-row output 520 to a single row output 504. In some aspects, the single row output 504 may be stored in memory (e.g., 118).

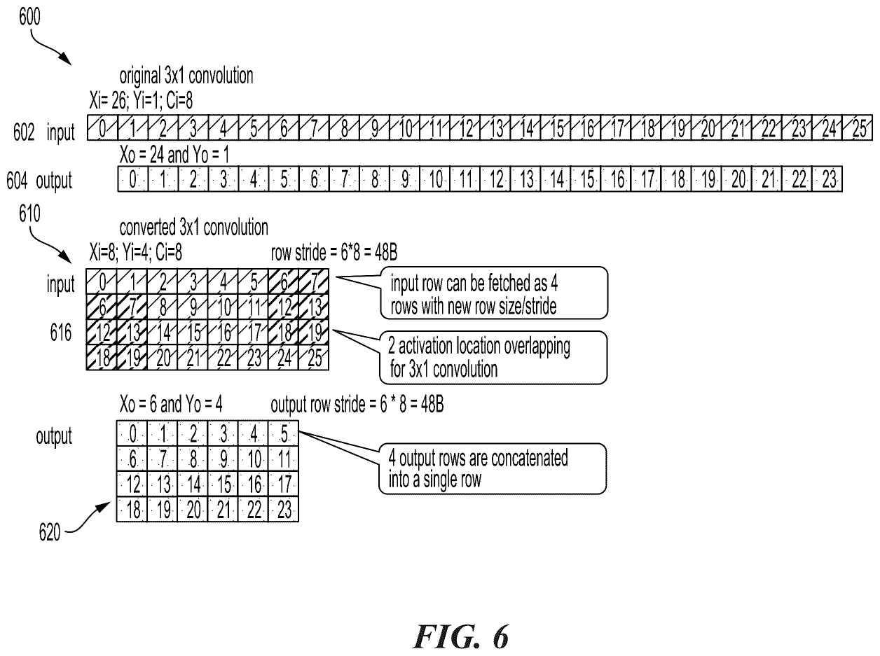

FIG. 6 is a diagram illustrating an example remapping of a 1D convolution 600, in accordance with various aspects of the present disclosure. Referring to FIG. 6, a 1D convolution may be remapped to a four-row convolution. That is, a single row input 602 may be remapped by splitting the single row input 602 into a multi-row input 610, for example, to more efficiently utilize an available MAC/control unit (CU) NPU datapath. In the example of FIG. 6, the single row input 602 may be remapped to a multi-row input 610 such that four rows of the multi-row input 610 may be concurrently processed to compute a multi-row output 620.

An artificial neural network (e.g., 350 of FIG. 3) may receive the single row input 602. The single row input 602 has 25 elements, for example. Of course this is merely an example, and the single row input 602 may include any number of elements. In the example of FIG. 6, a 3×1 convolution operation may be scheduled to be performed on the single row input 602 to generate an output 604.

The inputs (e.g., 602) of the convolution operation may be remapped to utilize available compute resources more efficiently. In the example, of FIG. 6, the hardware configuration may concurrently generate four rows of outputs (e.g., Yc=4). As such, the single row input 602 may be remapped to split the input 602 into four rows that may be fetched with a new row size (e.g., stride).

The number of rows of the input 602 is one (e.g., Yi=1). Thus, the split factor (N) in this example is four (e.g., Yc/Yi=4). Accordingly, the output 604 may be mapped to split the output 604 into four rows (e.g., multi-row output 620). Then, the single row input 602 may be mapped to split the input 602 into four rows in the multi-row input 610.

The split activation row size Xi′ may then be determined based on the size of the Xo′. As shown in the FIG. 6, Xo′=6, and the kernel dimension is three. Thus, the desired split activation row size Xi′=8 (e.g., Xi′=6+3−1=8). That is, the mapped input may include eight elements in each row.

Similar to the example of FIG. 5, overlapped or repeated elements may be used as the end of rows 1-3 of the multi-row input 610 and the beginning of rows 2-4 of the multi-row input (shown as overlapped elements 616).

Then, having remapped the single row input 602 as the multi-row input 610, the convolution operations may be performed by fetching the elements on the input 602 in accordance with the remapping such that the four rows of remapped input 602 may be concurrently processed to generate the multi-row outputs 620. In some aspects, the rows of the multi-row output 620 may be concatenated to remap the multi-row output 620 to a single row output 604. In some aspects, the single row output 604 may be stored in memory (e.g., 118).

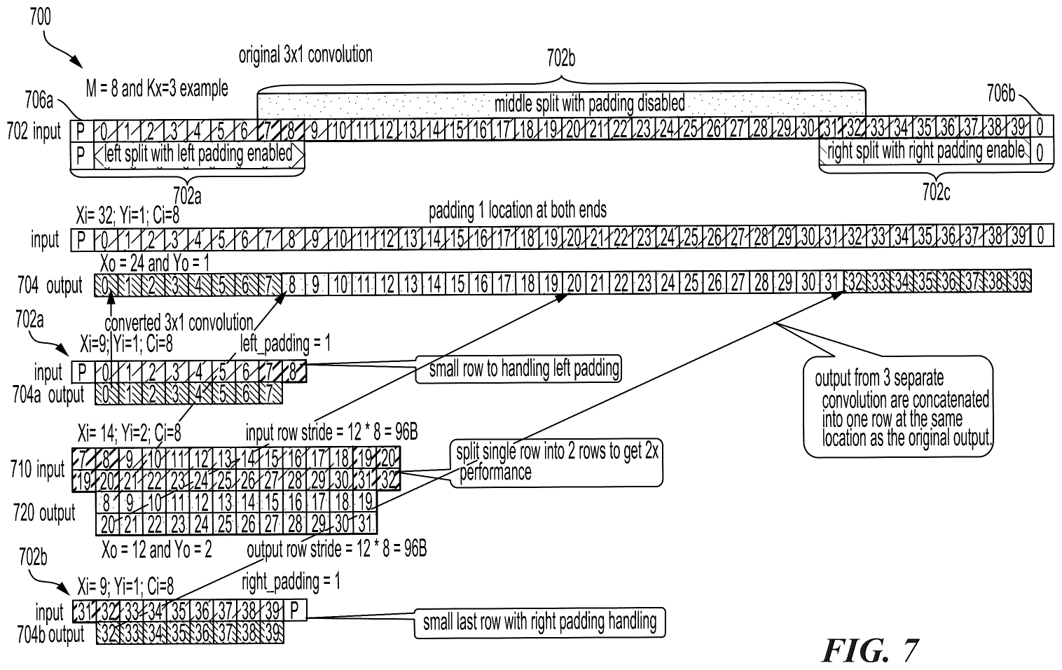

FIG. 7 is a block diagram illustrating an example remapping of a 1D convolution 700 with hardware padding, in accordance with various aspects of the present disclosure. Hardware padding may be employed for certain inputs. Hardware padding involves filling unused portions of a data structure with blank or null characters, for instance. Hardware padding may be performed, for example, because some hardware may not be able to read non-aligned data. To avoid alignment faults due to accessing unaligned memory, the input data may be padded with blank or null characters.

Referring to FIG. 7, an input 702 having padding at both ends of the input is shown. The input 702 may be split into three portions (702a, 702b, and 702c) to handle the input when padding is employed. A first portion of the input 702a may include a padding element 706a and elements 0-8. A second portion of the input 702c includes a padding element 706b and elements 31-39. A third portion of the input 702b includes elements 7-32. The third portion of the input 702b has elements 7 and 8 that overlap with the first portion of the input 702a and elements 31 and 32 that overlap with the second portion of the input 702c.

The third portion of the input 702b that does not include padding may be remapped in a manner similar to that described above with respect to FIGS. 5 and 6. That is, the third portion of the input 702b may be remapped into a multi-row input 710 to utilize available MAC/CU units (e.g., NPU 108/428). In the example of FIG. 7, the hardware may currently process two rows of inputs (e.g., 710) to generate two rows of outputs (e.g., 720).

On the other hand, the first portion 702a and the second portion 702c of the input 702 may be processed as single row inputs without remapping. Because the padding elements 706a, 706b include blank or null characters, the convolution operations including the padding elements may be skipped. Then, the elements 0-7 of the first portion 702a may be subjected to a 3×1 convolution operation to generate elements 0-7 of outputs 704a. Similarly, the elements 31-39 may be subjected to a 3×1 convolution operations to generate elements 32-39 of outputs 704b. The convolution operations for the right padding element 706b may be skipped.

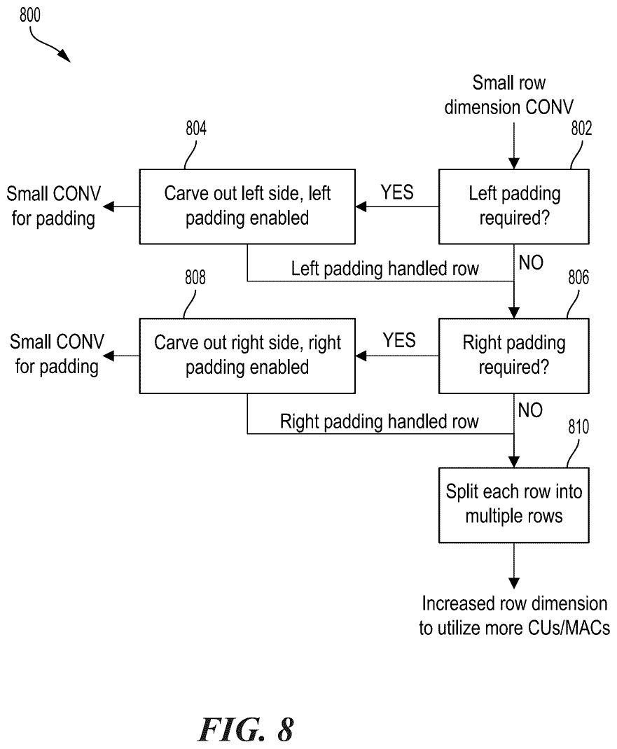

FIG. 8 is a flow diagram illustrating an example process 800 for remapping of a 1D convolution with hardware padding, in accordance with various aspects of the present disclosure. Referring to FIG. 8, when padding is employed, a padding M may be determined. The padding may include a left padding (at the beginning of an input), a right padding (at the end of the input sequence), or both. At block 802, the process 800 may determine whether left padding (e.g., 706a) is used. In some aspects, the padding M may be determined by the NPU's concurrent horizontal location, for example. If left padding is used, at block 804, a left portion may be determined. After the padding M has been determined, a left portion of the input (e.g., 702a) may be defined with a length given by M+(Kx−1)/2 with left padding enabled.

Then, the example process 800 may continue to block 806. At block 806, the process 800 may determine whether right padding (e.g., 706b) is used. If right padding is used, at block 808, a right portion of the input (e.g., 702b) may be determined. The right portion may also be defined with length=M+(Kx−1)/2, with right padding enabled. Then, at block 810, a middle portion (e.g., starting from a location M-1 until a first element of the left portion) may be determined. The middle portion may be remapped to a multi-row input and may be processed concurrently based on the available MAC/CU of the NPU.

On the other hand, the left portion of the input (e.g., 702a) and the right portion of the input (702b) may not be remapped, but instead may each be processed using one-dimensional convolution operations.

Thereafter, the outputs of the respective portions of the output (e.g., 704a, 704b, and 720) may be concatenated into a one row output at the same locations for an original output (e.g., 704).

Accordingly, aspects of the present disclosure may provide increased processing efficiency (e.g., 2×, 4×, or 8×) without increased hardware costs. Moreover, the processing efficiency may be improved without any activation/weight/output copying or reformatting. Instead, the view of the input and output tensor may change with a new horizontal size and row stride settings employed for fetching the tensors from memory.

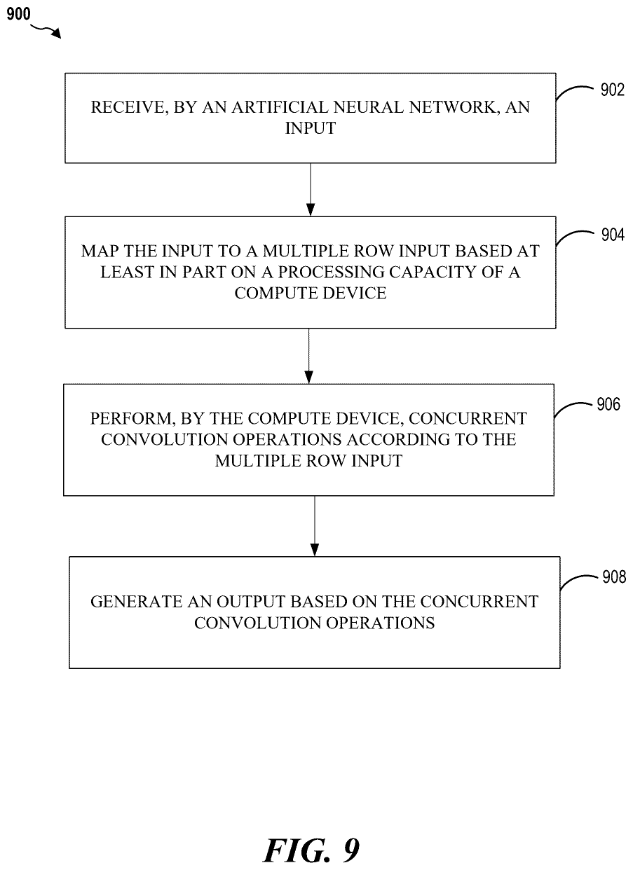

FIG. 9 is a flow diagram illustrating a processor-implemented method 900 for remapping one-dimensional inputs to multi-row input for concurrent convolution operations, in accordance with various aspects of the present disclosure.

The processor-implemented method 900 may be performed by one or more processors such as the NPU (e.g., 108, 428), and/or other processing unit (e.g., CPU 102/422, GPU 104/426, or DSP 106/424), for example.

Referring to FIG. 9, at block 902, the one or more processors receive, by an artificial neural network, an input. For example, as described with reference to FIG. 5, an artificial neural network (e.g., DCN 350 of FIG. 3) may receive a 1D (e.g., single row) input 502. The input may, for instance, comprise a one-dimensional tensor or a multi-dimensional tensor. The single row input 502 may comprise (but is not limited to) an audio input, biomedical data, or an indication of a power/electrical signal, for instance.

At block 904, the one or more processors map the input to a multiple row input based at least in part on a processing capacity of a compute device. As described, for instance, with reference to FIG. 5, the single row input 502 may be remapped as a multi-row input 510 based on the available compute resources. The remapping may split the single row input 502 in two, such that input rows may be fetched as two rows with a new row size (e.g., stride). To determine the size of the split (e.g., the number of rows) for the single row input 502, the number of concurrent outputs that may be generated by the hardware configuration may be employed, for example.

At block 906, the one or more processors perform, by the compute device, concurrent convolution operations according to the multiple row input. For example, as described with reference to FIG. 5, having remapped the single row inputs 502 as multi-row input 510, the convolution operations may be performed by fetching the elements on the single row input 502 in accordance with the remapping, such that the two rows of the multi-row input 510 may be concurrently processed to generate the multi-row outputs 520.

At block 908, the one or more processors generate an output based on the concurrent convolution operations. As described, for instance, with reference to FIG. 5, in accordance with the remapping, the multi-row input 510 may be concurrently processed to generate the multi-row outputs 520.

### Example Aspects

Aspect 1: An apparatus, comprising:
at least one memory; and
at least one processor coupled to the at least one memory, the at least one processor configured to:
   receive, by an artificial neural network, an input;
   map the input to a multiple row input based at least in part on a processing capacity of a compute device;
   perform, by the compute device, concurrent convolution operations according to the multiple row input; and
   generate an output based on the concurrent convolution operations.

Aspect 2: The apparatus of Aspect 1, in which the input comprises a one-dimensional tensor.

Aspect 3: The apparatus of Aspect 1 or 2, in which the at least one processor is further configured to compute, by a multiply-accumulate (MAC) unit of a neural processing unit, the concurrent convolution operations according to the multiple row input.

Aspect 4: The apparatus of any preceding Aspect, in which the at least one processor is further configured to map the input into the multiple row input by adapting fetching of the input from memory.

Aspect 5: The apparatus of any preceding Aspect, in which the input includes hardware padding before a first element of the input or after a last element of the input.

Aspect 6: The apparatus of any preceding Aspect, in which the at least one processor is further configured to:
split the input into multiple portions;
remap a first portion of the input without the hardware padding into the multiple row input; and
process a second portion of the input, the second portion including the hardware padding, without mapping the second portion to the multiple row input.

Aspect 7: The apparatus of any preceding Aspect, in which the input comprises a multi-dimensional input.

Aspect 8: A processor-implemented method performed by one or more processors, the processor-implemented method comprising:
receiving, by an artificial neural network, an input;
mapping the input to a multiple row input based at least in part on a processing capacity of a compute device;
performing, by the compute device, concurrent convolution operations according to the multiple row input; and
generating an output based on the concurrent convolution operations.

Aspect 9: The processor implemented method of Aspect 8, in which the input comprises a one-dimensional tensor.

Aspect 10: The processor-implemented method of Aspect 8 or 9, in which the compute device comprises a multiply-accumulate (MAC) unit of a neural processing unit.

Aspect 11: The processor-implemented method of any of Aspects 8-10, in which the input is mapped into multiple rows by adapting fetching of the input from memory.

Aspect 12: The processor-implemented method of any of Aspects 8-11, in which the input includes hardware padding before a first element of the input or after a last element of the input.

Aspect 13: The processor-implemented method of any of Aspects 8-12, further comprising:
splitting the input into multiple portions;
remapping a first portion of the input without the hardware padding into the multiple row input; and
processing a second portion of the input, the second portion including the hardware padding, without mapping the second portion to the multiple row input.

Aspect 14: The processor-implemented method of any of Aspects 8-13, in which the input comprises a multi-dimensional input.

Aspect 15: An apparatus, comprising:
means for receiving, by an artificial neural network, an input;
means for mapping the input to a multiple row input based at least in part on a processing capacity of a compute device;
means for performing, by the compute device, concurrent convolution operations according to the multiple row input; and
means for generating an output based on the concurrent convolution operations.

Aspect 16: The apparatus of Aspect 15, in which the input comprises a one-dimensional tensor or a multi-dimensional tensor.

Aspect 17: The apparatus of Aspect 15 or 16, further comprising means for computing, by a multiply-accumulate (MAC) unit of a neural processing unit, the concurrent convolution operations according to the multiple row input.

Aspect 18: The apparatus of any of Aspects 15-17, further comprising means for mapping the input into the multiple row input by adapting fetching of the input from memory.

Aspect 19: The apparatus of any of Aspects 15-18, in which the input includes hardware padding before a first element of the input or after a last element of the input.

Aspect 20: The apparatus of any of Aspects 15-19, further comprising:
means for splitting the input into multiple portions;
means for remapping a first portion of the input without the hardware padding into the multiple row input; and
means for processing a second portion of the input, the second portion including the hardware padding, without mapping the second portion to the multiple row input.

In one aspect, the receiving means, mapping means, performing means, splitting means, remapping means, computing means, and/or generating means may be the CPU 102/422, GPU 104/426, NPU 108/428, program memory associated with the CPU 102/422, GPU 104/426, or NPU 108/428, memory 118, and/or the routing connection processing unit 216 configured to perform the functions recited. In another configuration, the aforementioned means may be any module or any apparatus configured to perform the functions recited by the aforementioned means.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used, the term “determining” encompasses a wide variety of actions. For example, “determining” may include calculating, computing, processing, deriving, investigating, looking up (e.g., looking up in a table, a database, or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used, a phrase referring to “at least one of” a list of items refers to any combination of those items, including single members. As an example, “at least one of: a, b, or c”is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used, include compact disc (CD), laser disc, optical disc, digital versatile disc (DVD), floppy disk, and Blu-ray® disc where disks usually reproduce data magnetically, while discs reproduce data optically with lasers. Thus, in some aspects, computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented. For example, such a computer program product may comprise a computer-readable medium having instructions stored (and/or encoded) thereon, the instructions being executable by one or more processors to perform the operations described. For certain aspects, the computer program product may include packaging material.

Further, it should be appreciated that modules and/or other appropriate means for performing the methods and techniques described can be downloaded and/or otherwise obtained by a user terminal and/or base station as applicable. For example, such a device can be coupled to a server to facilitate the transfer of means for performing the methods described. Alternatively, various methods described can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. An apparatus, comprising:
at least one memory; and
at least one processor coupled to the at least one memory, the at least one processor configured to:
receive, by an artificial neural network, an input;
map the input to a multiple row input based at least in part on a processing capacity of a compute device;
perform, by the compute device, concurrent convolution operations according to the multiple row input; and
generate an output based on the concurrent convolution operations.

2. The apparatus of claim 1, in which the input comprises a one-dimensional tensor.

3. The apparatus of claim 1, in which the at least one processor is further configured to compute, by a multiply-accumulate (MAC) unit of a neural processing unit, the concurrent convolution operations according to the multiple row input.

4. The apparatus of claim 1, in which the at least one processor is further configured to map the input into the multiple row input by adapting fetching of the input from memory.

5. The apparatus of claim 1, in which the input includes hardware padding before a first element of the input or after a last element of the input.

6. The apparatus of claim 5, in which the at least one processor is further configured to:
split the input into multiple portions;
remap a first portion of the input without the hardware padding into the multiple row input; and
process a second portion of the input, the second portion including the hardware padding, without mapping the second portion to the multiple row input.

7. The apparatus of claim 1, in which the input comprises a multi-dimensional input.

8. A processor-implemented method performed by one or more processors, the processor-implemented method comprising:
receiving, by an artificial neural network, an input;
mapping the input to a multiple row input based at least in part on a processing capacity of a compute device;
performing, by the compute device, concurrent convolution operations according to the multiple row input; and
generating an output based on the concurrent convolution operations.

9. The processor implemented method of claim 8, in which the input comprises a one-dimensional tensor.

10. The processor-implemented method of claim 8, in which the compute device comprises a multiply-accumulate (MAC) unit of a neural processing unit.

11. The processor-implemented method of claim 8, in which the input is mapped into multiple rows by adapting fetching of the input from memory.

12. The processor-implemented method of claim 8, in which the input includes hardware padding before a first element of the input or after a last element of the input.

13. The processor-implemented method of claim 12, further comprising:
splitting the input into multiple portions;
remapping a first portion of the input without the hardware padding into the multiple row input; and
processing a second portion of the input, the second portion including the hardware padding, without mapping the second portion to the multiple row input.

14. The processor-implemented method of claim 8, in which the input comprises a multi-dimensional input.

15. An apparatus, comprising:
means for receiving, by an artificial neural network, an input;
means for mapping the input to a multiple row input based at least in part on a processing capacity of a compute device;
means for performing, by the compute device, concurrent convolution operations according to the multiple row input; and
means for generating an output based on the concurrent convolution operations.

16. The apparatus of claim 15, in which the input comprises a one-dimensional tensor or a multi-dimensional tensor.

17. The apparatus of claim 15, further comprising means for computing, by a multiply-accumulate (MAC) unit of a neural processing unit, the concurrent convolution operations according to the multiple row input.

18. The apparatus of claim 15, further comprising means for mapping the input into the multiple row input by adapting fetching of the input from memory.

19. The apparatus of claim 15, in which the input includes hardware padding before a first element of the input or after a last element of the input.

20. The apparatus of claim 19, further comprising:
means for splitting the input into multiple portions;
means for remapping a first portion of the input without the hardware padding into the multiple row input; and
means for processing a second portion of the input, the second portion including the hardware padding, without mapping the second portion to the multiple row input.
